(19) United States
(12) Patent Application Publication
(10) Pub. No.: US 2016/0289456 A1
(43) Pub. Date: Oct. 6, 2016

(54) NO VOC PAINT

(71) Applicant: Rust Bullet, LLC, Reno, NV (US)

(72) Inventors: David Paul Ciglar, Reno, NV (US); Frank Lee Ciglar, Reno, NV (US); Jeramie Wade Burke, Reno, NV (US)

(73) Assignee: Rust Bullet, LLC, Reno, NV (US)

(21) Appl. No.: 15/090,530

(22) Filed: Apr. 4, 2016

Related U.S. Application Data
(60) Provisional application No. 62/142,914, filed on Apr. 3, 2015.

(51) Int. Cl. C09D 5/00; C09D 175/04; C09D 7/12

(52) U.S. Cl. CPC C09D 5/00; C09D 7/1291; C09D 175/04

(57) ABSTRACT

A new low VOC coating composition includes an aliphatic polyisocyanate based on isophorone diisocyanate and hexamethylene diisocyanatepolyacrylate; a solvent-free, low viscosity aliphatic polyisocyanate resin based on hexamethylene diisocyanate; and a catalyst. Optionally, the composition further optionally contains a defoamer, a liquid rheology additive, micro spheres and pigments.

### TECHNICAL FIELD

The present invention relates to low volatile-organic-compound (VOC) paint and more particularly to a virtually no-VOC paint.

### BACKGROUND

For many years, paint manufacturers and other companies had moved to volatile organic compounds (VOC's) for their benefits of dissolving and/or suspending other ingredients such as pigments and of permitting paint to dry more quickly than water-based paints. Inspired by nature that uses VOC's for inter-plant and plant-animal communication (e.g., fragrances we perceive), manufacturers manufactured tons of VOC's annually. Paint manufacturers and car manufacturers have long used controlled environments, including separate breathing systems to limit employee exposure to VOC's. Fast-drying paints have enabled redecorating offices and dwellings on the fly, with rapid return of occupants to their work and living spaces. However, long days and/or nights spent in those spaces can be problematic.

Public awareness had grown that indoor spaces can make people sick. The sources of the sickness had finally been attributed to exposure to VOC's. Respiratory, allergic, or immune effects in infants or children are associated with man-made VOC's and other indoor or outdoor air pollutants. Studies also showed that leukemia and lymphoma can increase through prolonged exposure of VOC's in the indoor environment. Since many people spend much of their time indoors, long-term exposure to VOC's in the buildings has contributed to sick building syndrome. In offices, airborne VOC's also result from new furnishings, wall coverings, and even office equipment such as photocopy machines, which off-gas VOC's into the air. Good ventilation and air-conditioning systems are helpful at reducing VOC's in the indoor environment.

Responding to these health risks, many jurisdictions have devised their own definitions, limits and even ways of calculating VOC presence. Some have initiated graduated standards, with ever decreasing allowances. Industries have also devised their own standards and safety insignia. There are also ISO standards of various types. Paint and coating manufacturers currently traverse a patchwork of various regulations to provide the large quantities of paints and coatings required by the markets.

### SUMMARY

In one embodiment, there is provided a low VOC coating composition including an aliphatic polyisocyanate mixture of isophorone diisocyanate and hexamethylene diisocyanatepolyacrylate; a solvent-free, low viscosity aliphatic polyisocyanate resin with hexamethylene diisocyanate; and a polyurethane promoting catalyst.

Preferably the aliphatic polyisocyanate mixture has isophorone diisocyanate and hexamethylene diisocyanatepolyacrylate and is DESMODUR® XP-2673. And the solvent-free, low viscosity aliphatic polyisocyanate resin with hexamethylene diisocyanate is DESMODUR N 3400.

In another embodiment, the low VOC coating composition additionally includes a polymeric defoamer. This polymer defoamer is preferably about 1-2% of the low VOC coating composition. The polyurethane promoting catalyst preferably includes dibutyltin dilaurate. This catalyst is preferably about 1 to 2% of the low VOC coating composition.

In another embodiment, the low VOC coating composition additionally includes a liquid rheology additive. This liquid rheology additive is preferably about 1% to about 2% of the low VOC coating composition.

In another embodiment, the low VOC coating composition additional includes microspheres. The microspheres are preferably about 5% to about 30% of the low VOC coating composition. The microspheres are preferably alkali alumino-silicate ceramic microspheres.

In another embodiment, the low VOC coating composition includes aluminum flakes. The aluminum flakes are preferably about 10% to about 30% of the low VOC coating composition.

In another embodiment, the low VOC coating composition has at least one pigment. The pigment preferably is about 4% to about 40% of the low VOC coating composition.

In yet another embodiment, a low-VOC coating composition includes a. an aliphatic polyisocyanate mixture comprising polyisocyanate based on HDI, aliphatic polyisocyanate, n-butyl acetate and isophorone diisocyanate (IPDI); b. a solvent free, low viscosity aliphatic polyisocyanate resin comprising hexamethylene diisocyanate; c. a polymer defoamer; d. a liquid rheology additive; and e. a polyurethane promoting catalyst.

Preferably the aliphatic polyisocyanate mixture includes polyisocyanate based on HDI (15-40%), aliphatic polyisocyanate (40-70%), n-butyl acetate (10-30%) and isophorone diisocyanate (IPDI, <0.35%). The polymer defoamer is preferably about 1-2% of the low VOC coating composition. In yet another embodiment, the low VOC coating composition additionally has aluminum flakes that comprise about 10-30% of the low VOC coating composition.

### BRIEF DESCRIPTION OF THE DRAWINGS

FIG. 1 displays processed drawdown cards.

FIG. 2 displays a set of drawdown samples of our aluminum-flake coatings.

FIG. 3 depicts a set of drawdown samples of our aluminum-flake coatings.

FIG. 4 shows a close up of coated Q-panel of our aluminum flake coating.

FIG. 5 displays two different drawdown tests of different formulations of our aluminum flake coating.

FIG. 6 shows a drawdown card with different formulations of orange paint.

FIG. 7 shows a drawdown card with different formulations of blue paint.

### DETAILED DESCRIPTION

Realizing that VOC's have been a problem, we were eager to try a new paint base that did not utilize any VOC's. Based on our experience, we experimented with various formulations, testing them with results shown in the Drawings.

In one embodiment, a new coating composition that is a no-VOC formulation utilizing the new Bayer Material Science Desmodur® XP-2763 resin that, along with Desmodur 3400, enabled us to produce a unique coating that not only employs conventional pigments, but also flaked aluminum and no pigment at all for a clear coating. Other preferred constituents include leveling and anti-cratering additive (BYK-361N, www.BYK.com), a silicone and polymeric defoamer (BYK-A530), a catalyst (DABCO® T-12, www.anproducts.com), and/or a liquid rheology additive (BYK-D410). We have tested a variety of coloring agents, including pigments (e.g., black AN100, Clariant Hostatint) and aluminum flakes (preferably Schlenk Polytop 0900SA). In another preferred embodiment we first soaked the Schlenk aluminum flakes in benzene, 1-chloro-4 (trifluoromethyl) (OXSOL® 100, www.islechem.com) before adding to the inventive formulation. In some embodiments, we increased resistance to abrasion with an optional ingredient, preferably alkali alumino-silicate ceramic microspheres (W-410, 3M®, http://www.shop3m.com/3m-ceramic-microspheres-white-grade-w-410-small-bag.html?WT.mc_ev=clickthrough&WT.mc_id=3M-com-GoogleOneBox-70070579605).

Desmodur XP-2763 has been described as a hardener component for weather-stable coating systems and as “aliphatic polyisocyanate based on isophorone diisocyanate (PDI) and hexamethylene diisocyanate (HDI) supplied in butyl acetate.” (Bayer Product Literature downloaded on Mar. 13, 2015). A material safety data sheet for Desmodur XP-2763 discloses the primary ingredients are polyisocyanate based on HDI (15-40%), aliphatic polyisocyanate (40-70%), n-butyl acetate (10-30%) and isophorone diisocyanate (IPDI, <0.35%). Minor ingredients include dibutyl phosphate (<0.1%) and methanol (<0.1%). This new product is said to require the addition of 0.05%-0.02% dibutyltin dilaurate (based on solid resin) to enable the formulation of a one-component, hard, tough finish. This polyisocyanate additive also can be used in two-component polyurethane exterior coatings.

Desmodur N 3400 has been described as “a solvent free low viscosity aliphatic polyisocyanate resin based on hexamethylene diisocyanate (HDI).” (Bayer Product Literature downloaded on Mar. 13, 2015). It can be “used as a binder for solvent free, one-component moisture curing polyurethane clear coats.” Specifically, it includes homopolymer of hexamethylene diisocyanate (≧95%) and hexamethylene-1,6-diisocyanate (≦0.5%), according to a recent material safety data sheet.

Into this mix of polyisocyanate resins, a polyacrylate-based surface additive for solvent-borne and solvent-free coatings is used herein. It improves surface leveling and prevents craters. Our preferred surface additive is BYK-361 N, which is the solvent-free version BYK-358 N and is an acrylate copolymer. Both are considered suitable for ambient curing of plastic systems.

In some embodiments, we used a catalyst that promotes the urethane (polyol-isocyanate) or gelling reaction for the production of flexible and rigid polyurethane coatings. A preferred catalyst is DABCO T-12 dibutyltin dilaurate (DBTDL). The catalyst was used at about 1-2%.

In some embodiments, we employed an appropriate liquid rheology additive to improve paint flow and avoid sagging and settling. We selected a solution of a modified urea that is appropriate for medium-polarity solvent-borne and solvent-free coating systems as well as ambient-curing resin systems. Post-addition by the consumer is possible. A preferred rheology additive is BYK-D410. We have used this in concentrations ranging from about 1% to about 2%.

In some embodiments, we also used a silicone and polymeric defoamer (also called an air release agent). A preferred defoamer is BYK-A530 that is formulated for solvent-free formulations. It is 95-96% hydrotreated light petroleum distillates.

Optionally, we added alkali alumino-silicate ceramic microspheres to contribute to a harder, abrasion-resistant surface. We prefer 3M™ Ceramic Microspheres (W-410) that are hard, inert, solid, white-colored, fine spherical particles with a typical whiteness (L Value) of 95 or greater and a particle size of 0.3-24 microns. They have the appearance of a fine white powder. We varied the amount of microsphere from about 10% to about 25%.

We have used a variety of pigments, including aluminum flakes and various colors, such as blue, black, red, green, and purple. The pigment loads varied from 10% to 30% and amounts in between.

We have used aluminum flakes (Schlenk Polytop 0900SA, stabilized aluminum flakes in 4-chloro-α,α,α-trifluorotoluene). In a preferred embodiment we first soaked the Schlenk aluminum flakes in benzene, 1-chloro-4 (trifluoromethyl) (OXSOL® 100, www.islechem.com) before adding to the inventive formulation. To provide an even lower VOC content, we are obtaining a new aluminum formulation with OXSOL.

The new composition is used like a traditional paint or other coating product. Before application, the substrate to be coated is preferably prepared as follows: The substrate is rendered dry and free of loose rust, moisture, dirt, oily substances and loose paint. As appropriate, the foregoing substances were removed by lightly scraping, sanding or wire brushing. A suitable agent for metal surface cleaning and conditioning prior to coating application is RUST BULLET® metal blast.

Preferably the existing paint or other coating that cannot be removed is scuffed up with 100-150 grit sandpaper. This scuffing is also preferred if a previous coat of a RUST BULLET coating was applied more than 72 hours earlier. Aside from the aforementioned steps, no additional surface preparation may be necessary.

The inventive composition is applied by paint brush, roller, or spray equipment, such as an airless sprayer, conventional airless sprayer or high volume, low pressure (HVLP) sprayer. The inventive composition goes on with a high build film thickness and may need a minimum of two coats when used alone. Used as a topcoat, a single coat of the inventive composition may suffice. Additional coats are applied to build up the film as necessary for the type of application. Thicker films tend to be more anti-corrosive, longer lived and suitable for environments that are acidic or salty. Drying times between coats are about one hour when the ambient humidity is 70%. The inventive composition can be applied in a wide range of atmospheric and surface conditions. Exemplary ranges include 1) ambient temperature ranges from about 35° F. to about 110° F.; 2) ambient humidity between about 10% and 90%; and 3) substrate temperature between about 32° F. and about 190° F.

Post-application, the inventive coating has been observed to handle temperatures as high as 314° F. continuously or spikes of up to 625° F. for up to 72 hours. Post-application cleanup requires solvents such as RUST BULLET solvent, acetone, etc.

### Example 1

### Clear Product

We prepared a 50-gallon batch of clear, unpigmented product by adding the following quantities of components in the order listed:

| Ingredient | Weight (lbs) | Percentage |
|---|---|---|
| Desmodur XP-2763 | 269.54 | 59.37 |
| Desmodur N-3400 | 174.835 | 38.51 |
| BYK-361N | 1.362 | 0.3 |
| BYK-A530 | 3.178 | 0.7 |
| Dabco T-12 | 5.085 | 1.12 |

The mixture was then mixed on medium (high sheer) for 15-20 minutes until the mixture appeared homogeneous.

### Example 2

### Pigmented Product

The base of Example 1 can be used for a pigmented coating. This is accomplished with a 10-30% pigment load for high opacity and color coverage. Preferably a rheology modifier (BYK D-410) is added along with more air release additive (facilitated by BYK-A 530) to achieve sag resistance from about 6 to 12 mils. For example, starting with the clear base (Example 1) of Desmodur XP-2763 and Desmodur N-3400, the following components are added:

| Ingredient | Weight (lbs) | Percentage |
|---|---|---|
| Hostatint Black A-N | 100 | 20% |
| BYK-D410 | | 0.8% |
| BYK-A530 | | 1.0% |

This inventive combination was mixed for 15-20 minutes at low to medium sheer speeds until homogenous. Viscosity increased over a 48-hour period. Once maximum viscosity was reached, we found it preferable to add solvents, such as benzene, 1-chloro-4-(trifluoromethyl) such as OXSOL® 100 to the coating can be blended at low sheer for 10 minutes.

### Example 3

### Aluminum Flake Pigmented Coating

First, we soaked the desired amount of aluminum flakes (Schlenk polytop 0900SA) in benzene, 1-chloro-4-(trifluoromethyl) such as OXSOL® 100 (Mana, NYC) for 8 hr. The amount of Oxsol 100 is intended to form 20-30% of the final weight of the non-leafing aluminum flake paste. The amount of aluminum flakes is intended to form 20-23% of the final weight of the coating. Other forms of aluminum can also be used.

To the clear base of Example 1, the soaked aluminum flake mixture was added and blended for about 15-20 minutes on the low-sheer speed.

### Example 4

### Increased Abrasion Resistance, Aluminum Flake Coating

Abrasion resistance was increased by adding 10-20% by weight of 3M® D-410 microspheres to the combination of Example 3 and mixing at high speed for approximately 20 minutes to evenly disperse the microspheres. The microspheres are preferably soaked as described above for aluminum flakes.

### Example 5

### Test Results

We have tested a number of different formulations with the results shown in FIGS. 1 through 7. Specifically, the figures show the results of coverage and sag tests on standardized drawdown cards. These black and white cards are used to test paint formulations by accepting wet film deposits. When the paint effectively covers the black stripe, the paint formulation is considered to have good opacity. Opacity generally varies with the thickness of the paint. The contrast ratio has various definitions, including hiding power: the greater the hiding power, the less paint that is needed per unit area.

FIG. 1 shows a set of painted panels of low VOC formulations that are described row by row. The top row has seven samples. Starting at the left is sample 1 of a formulation with aluminum flakes sprayed on the panel, a single coating having been applied with 2.1-2.6 mils coverage. Sample 2 also containing aluminum flakes was sprayed onto the panel in a single coat and a thickness of about 3.0 mils. Sample 3 also containing aluminum flakes was sprayed onto the panel in a single coat and a thickness of about 2.3 mils. Sample 4 containing 20% by weight of W610 microspheres, 1% rheology modifier and 15% pigment load was applied by brush to a thickness of 1.8-2.4 mils cured single coat. Sample 5 containing 20% by weight of W410 microspheres, 1.5% rheology modifier, 10% pigment load and 1% air release agent A530 was applied by brush to a thickness of 3.1-4.1 mils cured single coat. Sample 6 containing 20% by weight of W610 microspheres, 1.5% rheology modifier and 10% pigment load was applied by brush to a thickness of 3.1-4.1 mils cured single coat. Sample 7 containing 20% by weight of W410 microspheres, 1.5% rheology modifier and 10% pigment load was applied by brush to a thickness of 2.5-3.5 mils cured single coat.

In the middle row of FIG. 1, there are also seven samples. Starting at the left, Sample 1 containing about 2% A530 defoamer, 25% W410 microspheres and 15% pigment load was applied by brush to a thickness of 2.9-5.3 mils cured single coat. Sample 2 containing about 1% A530 defoamer, 25% W410 microspheres and 15% pigment load was applied by brush to a thickness of 2.0-3.6 mils cured single coat. Sample 3 containing 25% W410 microspheres and 15% pigment load was applied by brush to a thickness of 5.1-8.1 mils cured single coat. Sample 4 containing about 2% A530 defoamer, 25% W410 microspheres and 15% pigment load was applied by brush to a thickness of 2.4-3.3 mils cured single coat. Sample 5 containing about 1% A530 defoamer, 25% W410 microspheres and 15% pigment load was applied by brush to a thickness of 2.8-3.1 mils cured single coat. Sample 6 containing about 1% A530 defoamer, 1.5% rheology modifier, 20% W410 microspheres and 10% pigment load was applied by brush to a thickness of 2.6-3.8 mils cured single coat. Sample 7 containing about 25% W610 microspheres, 1% rheology modifier and 15% pigment load was applied by brush to a thickness of 2.6-3.7 mils cured single coat.

Proceeding to the bottom row, and starting with Sample 1 on the left, Sample 1 shows the results of having stored the paint on a shelf for six weeks and then painting by brush on the panel at a thickness of 4.2-15.1 mils cured single coat that bubbled and required a simple formula adjustment. Sample 2 had also been shelved for six weeks and then was treated with 1% rheology modifier for SAG control prior to being applied by brush at a thickness of 2.2-3.5 mils cured single coating. Sample 3 containing 10% W410 microspheres, 1.5% rheology modifier and 15% pigment was also stored six weeks before being applied by brush to a thickness of 6.1-20.2 mils cured single coat that bubbled and required formula adjustment. Sample 4 containing 20% W410 microspheres, 1.5% rheology modifier and 3% pigment load was applied by brush at a thickness of 5.7-6.4 mils cured single coat that bubbled and required formula adjustment. Sample 5 containing 20% W610 microspheres, 1% rheology modifier and 30% pigment load was applied by brush at a thickness of 7.4-8.3 mils cured single coat that bubbled and required formula adjustment. Sample 6 containing 10% W610 microspheres, 1% rheology modifier and 30% pigment load was applied by brush at a thickness of 3.3-5.1 mils cured single coat that bubbled and required formula adjustment. Sample 7 containing 10% W610 microspheres, 1% rheology modifier, 1% air release A530 and 30% pigment load was applied by brush at a thickness of 6.1-12.2 mils cured single coat that bubbled and required formula adjustment. Clear Sample 8 containing 20% W410 microspheres and 1% rheology modifier was applied by brush at a thickness of 5.2-12.7 mils cured single coat that bubbled and required formula adjustment.

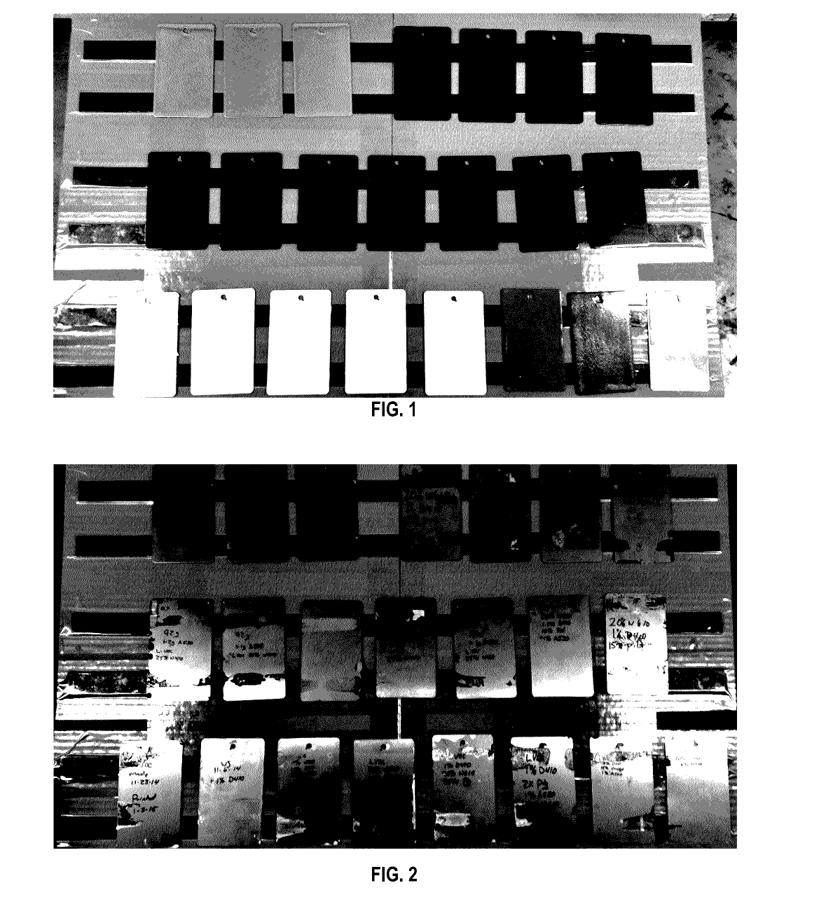

FIG. 2 also displays three rows of samples which are the backside of the panels shown in FIG. 1.

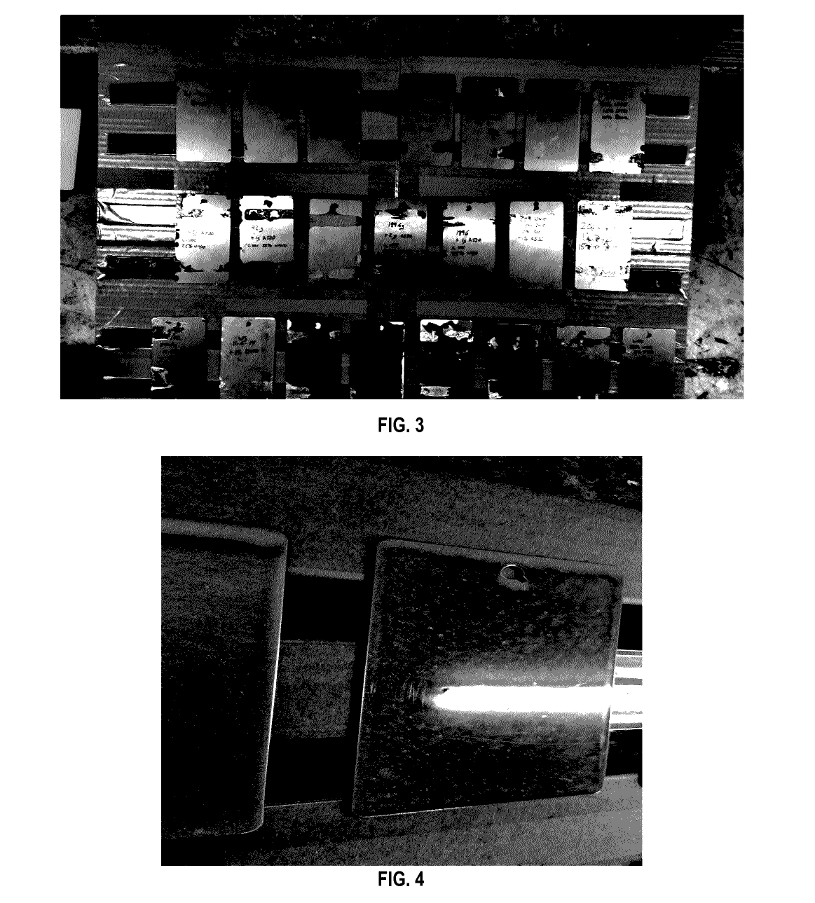

FIG. 3 also displays three rows of samples which are the same as FIG. 2 but from a different angle.

FIG. 4 displays enlargements of painted plates from FIG. 1.

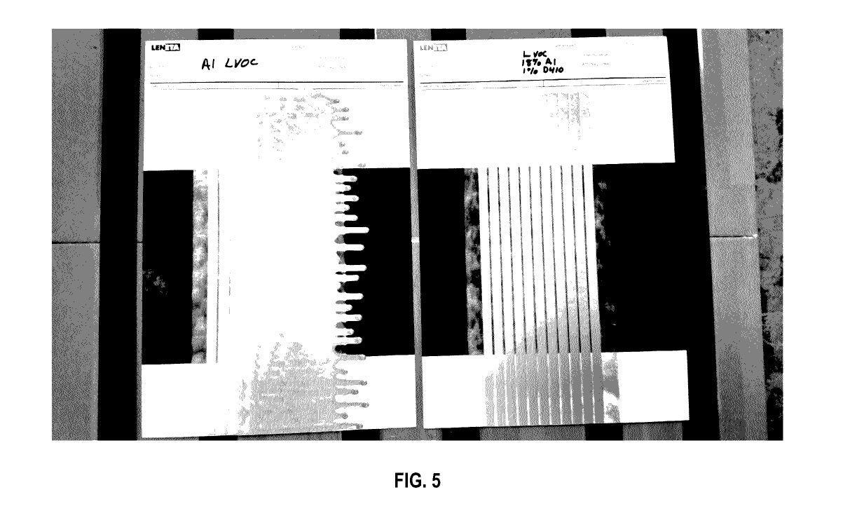

FIG. 5 displays two drawdown cards. The upper card is titled Al LVOC and is the control panel of low VOC base with 18% by weight of aluminum pigment load. It shows SAG resistance at 3 mils. The lower drawdown card LVOC received the same paint but with added rheology modifier at 1% weight. This shows SAG resistance of 12 mils, which is preferred.

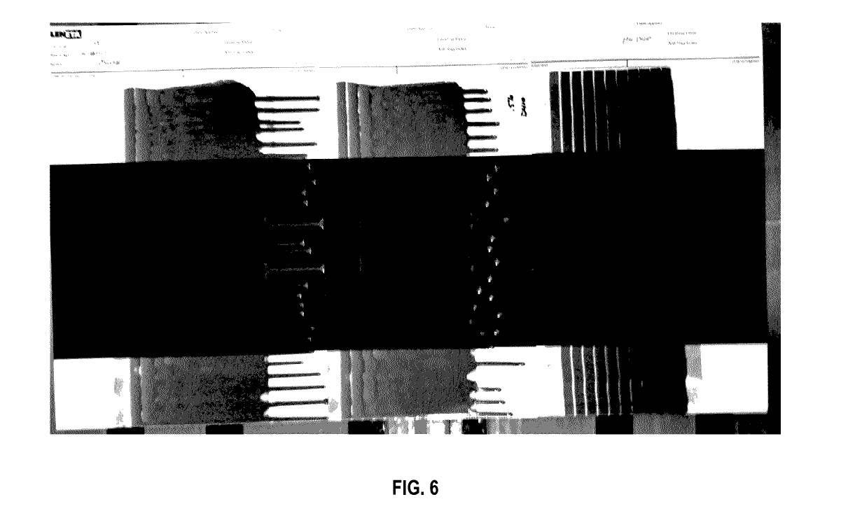

FIG. 6 shows three drawdown cards. The top drawdown card was covered with low VOC base containing 23.2% Hostatint pigment load. The drawdown shows SAG resistance of about 3 mils and poor opaqueness, in that the black stripe is visible through the paint sample. The middle drawdown card shows results after we added ½% rheology modifier; SAG resistance is still at 3 mils. The bottom drawdown card shows the result when the rheology modifier is increased to 1% by weight; the SAG resistance increased to about 8 mils.

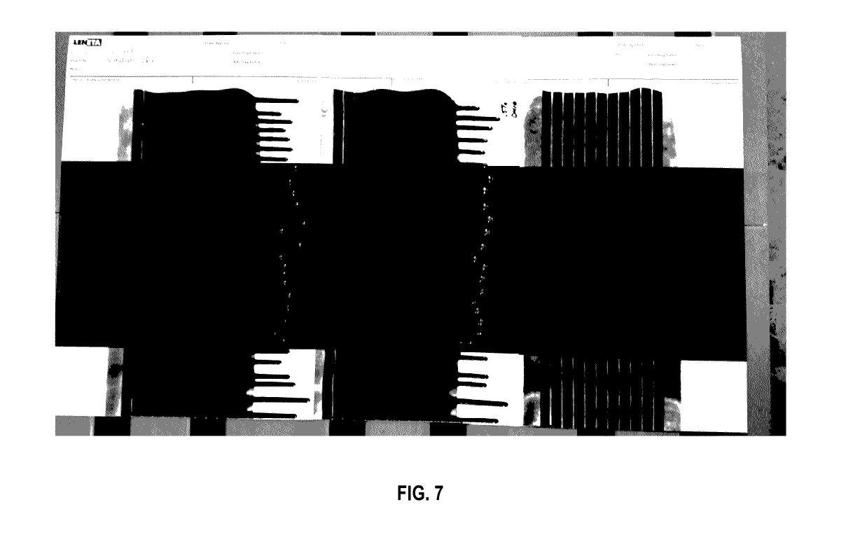

FIG. 7 shows three drawdown cards. The top drawdown card was covered with paint containing 11.3% Hostatint pigment load; the sample exhibited a SAG resistance of about 3 mils and poor opaqueness. The middle card shows the same formulation with added ½% rheology modifier and SAG resistance of 4 mils. The bottom card shows results after the total of rheology modifier was increased to 1%; SAG resistance was 12 mils, and coverage improved.

As can be seen from the foregoing examples, it is possible to use the various components in a variety of ways that still represent the invention. Furthermore, as can be seen from the foregoing examples, some of the components can be omitted, substituted or employed in different quantities.

For the purposes of promoting an understanding of the principles of the invention, reference will now be made to the exemplary embodiments illustrated in the drawings, and specific language will be used to describe the same. It will nevertheless be understood that no limitation of the scope of the invention is hereby intended. Any alterations and further modifications of the inventive features illustrated herein, and any additional application of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus appearances of the phrases an “embodiment,” and “example,” and similar language throughout this specification may, but do not necessarily, all refer to the same embodiment, to different embodiments, or to one or more of the figures. Additionally, reference to the words “embodiment,” “example” or the like for two or more features, elements, etc., does not mean that the features are necessarily related, dissimilar, the same, etc.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional un-recited elements or method steps. “Comprising” is to be interpreted broadly and including the more restrictive terms “consisting of” and “consisting essentially of.”

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage or characteristic described in connection with an embodiment is included in at least one embodiment of the present invention. Thus, discussion of the features and advantages, and similar language, throughout this specification may, but does not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

1. A low VOC coating composition comprising
a. an aliphatic polyisocyanate mixture comprising isophorone diisocyanate and hexamethylene diisocyanatepolyacrylate;
b. a solvent-free, low viscosity aliphatic polyisocyanate resin comprising hexamethylene diisocyanate; and
c. a polyurethane promoting catalyst.

2. The low VOC coating composition of claim 1 wherein the aliphatic polyisocyanate mixture comprising isophorone diisocyanate and hexamethylene diisocyanatepolyacrylate comprises DESMODUR® XP-2673.

3. The low VOC coating composition of claim 1 wherein the solvent, free, low viscosity aliphatic polyisocyanate resin comprising hexamethylene diisocyanate comprises DESMODUR N 3400.

4. The low VOC coating composition of claim 1 further comprising a polymer defoamer.

5. The low VOC coating composition of claim 4 wherein the polymer defoamer comprises about 1-2% of the low VOC coating composition.

6. The low VOC coating composition of claim 1 further comprising a liquid rheology additive.

7. The low VOC coating composition of claim 6 wherein the liquid rheology additive comprises about 1% to about 2% of the low VOC coating composition.

8. The low VOC coating composition of claim 1 wherein the polyurethane promoting catalyst comprises dibutyltin dilaurate.

9. The low VOC coating composition of claim 1 wherein the polyurethane promoting catalyst comprises about 1 to 2% of the low VOC coating composition.

10. The low VOC coating composition of claim 1 further comprising microspheres.

11. The low VOC coating composition of claim 10 wherein the microspheres comprise about 5% to about 30% of the low VOC coating composition.

12. The low VOC coating composition of claim 10 wherein the microspheres are alkali alumino-silicate ceramic microspheres.

13. The low VOC coating composition of claim 1 further comprising aluminum flakes.

14. The low VOC coating composition of claim 13 wherein the aluminum flakes comprise about 10% to about 30% of the low VOC coating composition.

15. The low VOC coating composition of claim 1 further comprising at least one pigment.

16. The low VOC coating composition of claim 15 wherein the pigment comprises about 4% to about 40% of the low VOC coating composition.

17. A low-VOC coating composition comprising
a. an aliphatic polyisocyanate mixture comprising polyisocyanate based on HDI, aliphatic polyisocyanate, n-butyl acetate and isophorone diisocyanate (IPDI);
b. a solvent free, low viscosity aliphatic polyisocyanate resin comprising hexamethylene diisocyanate;
c. a polymer defoamer;
d. a liquid rheology additive; and
e. a polyurethane promoting catalyst.

18. The low-VOC coating composition of claim 17 wherein the aliphatic polyisocyanate mixture comprises polyisocyanate based on HDI (15-40%), aliphatic polyisocyanate (40-70%), n-butyl acetate (10-30%) and isophorone diisocyanate (IPDI, <0.35%).

19. The low-VOC coating composition of claim 17, wherein polymer defoamer comprises about 1-2% of the low VOC coating composition.

20. The low VOC coating composition of claim 17 further comprising aluminum flakes that comprise about 10-30% of the low VOC coating composition.
